(19) United States
(12) Patent Application Publication
(10) Pub. No.: US 2010/0165793 A1
(43) Pub. Date: Jul. 1, 2010

(54) ULTRASONIC VIBRATION TRANSDUCER FOR ULTRASONIC DRILLING

(76) Inventor: Willi Haug, Freudenstadt-Musbach (DE)

Correspondence Address: MICHAEL J. STRIKER, 103 EAST NECK ROAD, HUNTINGTON, NY, 11743, US

(21) Appl. No.: 12/377,659

(22) PCT Filed: Sep. 11, 2007
(86) PCT No.: PCT/EP07/07889

§ 371 Date: Feb. 16, 2009

(30) Foreign Application Priority Data
Sep. 27, 2006 (DE) 10 2006 045 518.5

(51) Int. Cl. B06B 3/00

(52) U.S. Cl. 367/189

(57) ABSTRACT

The invention relates to an ultrasonic vibration transducer (1) for ultrasonic drilling in building material such as concrete, stone, brick or plaster. The invention proposes constructing the ultrasonic vibration transducer (1) as a tube-like hollow body which becomes narrower in the direction of its front end (2) and providing it with an exchangeable core (14). As a result of the hollow shape, a high degree of vibration amplification is achieved; by virtue of the exchangeable core (14), the ultrasonic vibration transducer (1) can be adapted to suit different tools (13).

The invention relates to an ultrasonic vibration transducer for ultrasonic drilling, having the features of the preamble of claim 1. The ultrasonic vibration transducer is intended especially for drilling in building materials such as concrete, stone, brick, clay or plaster.

For ultrasonic drilling, a tool is excited to longitudinal mechanical vibrations in the ultrasonic range, that is to say having frequencies of more than about 16 kHz to 20 kHz. The vibrations are generated by a vibration generator, which is also referred to as a vibration producer. Known vibration generators are often in the form of piezo vibration generators. The ultrasonic vibration transducer, which on its front end bears the tool, is clamped in the vibration generator. The “front end” refers herein to that end of the ultrasonic vibration transducer or of the tool which is remote from the vibration generator, that is to say that end of the tool which is placed on a workpiece for the purpose of drilling. The back end is consequently that end of the ultrasonic vibration transducer which is connected to the vibration generator. The tool can be a fixed component of the ultrasonic vibration transducer or can be releasably connected to the ultrasonic vibration transducer. At the same time, the tool can also be a fixing plug or anchor which drills its own anchorage hole. The purpose of the ultrasonic vibration transducer is to increase the amplitude of the vibration generated by the vibration generator or to increase the impulses and, as a result, the effectiveness of the tool. For design purposes, the complete vibrating system, comprising the vibration generator, more precisely its vibrating part(s), the ultrasonic vibration transducer and the tool, must be taken into consideration. This complete system has to be excited to vibration of a frequency or amplitude which brings about as rapid drilling progress as possible. Usually, this is the natural frequency of the system. It is not important that this frequency is in fact an ultrasonic frequency. Vibration transducers are also referred to as sonotrodes or converters.

U.S. Pat. No. 3,683,470 discloses an example of an ultrasonic drill having an ultrasonic vibration transducer. The ultrasonic vibration transducer thereof is a solid, rotationally symmetrical component, which becomes narrower, similarly to a cone, towards its front end, that is to say in the direction from the vibration generator towards the tool. In departure from a geometric conical shape having an envelope formed by straight lines, an envelope surface of the known ultrasonic vibration transducer is concavely rounded, that is to say the envelope lines are concavely curved.

The problem of the invention is to propose an ultrasonic vibration transducer for ultrasonic drilling having a high degree of effectiveness and good adaptability for tools.

The problem is solved by the features of claim 1. The ultrasonic vibration transducer according to the invention is a hollow body which becomes narrower in the direction of its front end. The internal space of the ultrasonic vibration transducer likewise becomes narrower in the direction of its front end. In particular, the wall thickness of the ultrasonic vibration transducer is approximately constant and the ultrasonic vibration transducer is thin-walled. Accordingly, it is not a basically solid body that has a bore but rather it is a tube-like body. The wall thickness is less than the diameter of the internal space of the ultrasonic vibration transducer.

Because of its hollow shape, the ultrasonic vibration transducer according to the invention is elastically deformable in the longitudinal direction with comparatively little force, that is to say the vibration excitation is transferred to the tool with a high degree of effectiveness. The ultrasonic vibration transducer has a high degree of amplitude amplification and/or applies powerful tool impulses to a workpiece.

In a preferred embodiment of the invention, the ultrasonic vibration transducer has, arranged in its internal space, a core, which is releasably and firmly connected to the ultrasonic vibration transducer. As a result of the releasability, the core is exchangeable and removable; by inserting a different core, especially of different weight, the ultrasonic vibration transducer can be adapted to suit different tools. “Firmly” is to be understood in the sense of a rigid connection that is immovable relative to the ultrasonic vibration transducer.

The core especially has only localised connection to the ultrasonic vibration transducer, for example at its middle or at one or both ends. In a preferred embodiment, the core is connected at its back end to the ultrasonic vibration transducer. The core can, as a result, vibrate relative to the ultrasonic vibration transducer. In particular, as a result of connection to the ultrasonic vibration transducer at only one location, the core does not stiffen the latter and accordingly does not impair its vibration capacity.

In an embodiment of the invention, a connection of the ultrasonic vibration transducer to the vibration generator firmly clamps the core in the ultrasonic vibration transducer. Play of the core in the ultrasonic vibration transducer is ruled out as a result.

In a preferred embodiment of the invention, the ultrasonic vibration transducer is a body of revolution.

In an embodiment of the invention, the ultrasonic vibration transducer and/or its internal space becomes wider in the direction of its front end in a region limited in the longitudinal direction. Overall the ultrasonic vibration transducer becomes narrower in the direction of its front end; in the case of the mentioned embodiment, the ultrasonic vibration transducer becomes wider in the direction of its front end in one or more region(s) limited in the longitudinal direction in contrast to its becoming generally narrower over its overall length. For example, the ultrasonic vibration transducer has a circumferential bulge, that is to say a circumferential convexity towards the outside. The bulge can be solid or also can be hollow in the form of a corrugation. Also possible is a circumferential convexity of the inside face of the wall of the ultrasonic vibration transducer. This embodiment of the invention makes possible a targeted embodiment of the ultrasonic vibration transducer for influencing or improving its vibration behaviour. For example, a longitudinal vibration bulge can be defined by means of a circumferential bulge. The longitudinal and transverse vibration behaviour is influenced by a circumferential bulge of the ultrasonic vibration transducer.

In an embodiment of the invention the ultrasonic vibration transducer is provided with at least one circumferential edge. The circumferential edge can be provided on the outside and/or inside of the ultrasonic vibration transducer. At the edge, the notional envelope lines of the ultrasonic vibration transducer change direction. The vibration behaviour of the ultrasonic vibration transducer is influencable in targeted manner also as a result thereof.

The invention will be explained in greater detail hereinbelow with reference to the examples of embodiments shown in the drawings. The three Figures show three ultrasonic vibration transducers according to the invention in axial section.

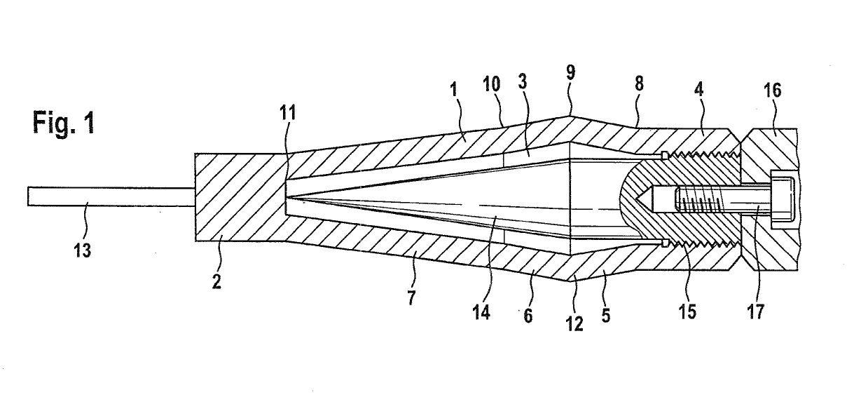

The ultrasonic vibration transducer 1 according to the invention that is shown in FIG. 1 is intended for ultrasonic drilling in building materials such as concrete, stone, brick or plaster. The ultrasonic vibration transducer 1 is a body of revolution and a hollow body; overall over its length it becomes narrower in the direction of its front end 2. An internal space 3 likewise becomes narrower in the direction of the front end 2. Overall over its length, the ultrasonic vibration transducer 1 can be regarded as approximately hollow-conical. It is tube-like, that is to say thin-walled in relation to its diameter; the wall thickness is constant. In the shown example of an embodiment, the ultrasonic vibration transducer 1 is manufactured from an aluminium alloy; manufacture from other metals or from non-metallic materials is not ruled out. The tube-like, hollow-body shape improves axial elasticity and, as a result, the vibration behaviour of the ultrasonic vibration transducer 1.

At the back end, the ultrasonic vibration transducer 1 has a hollow-cylindrical, that is to say tubular, portion 4, which in the direction of the front end 2 undergoes a first transition into a widening-out truncated hollow cone 5. That is followed by a truncated hollow cone 6 which becomes narrower in the direction towards the front end 2 and which undergoes a transition into a further hollow cone 7 that becomes narrower at a more acute cone angle towards the front end 2 of the ultrasonic vibration transducer 1. That third truncated hollow cone 7 undergoes a transition into the front end 2, which is in the form of a solid cylinder. The axial portions 4, 5, 6, 7, 2 of the ultrasonic vibration transducer 1 that are enumerated in this paragraph are integral with one another. In each case, the transitions from one to the other form circumferential edges 8, 9, 10, 11 on the inside and outside of the ultrasonic vibration transducer 1. The hollow-cylindrical portion 4 and the first and second truncated hollow cones 5, 6 are together approximately the same length axially as the third truncated hollow cone 7. Together the first and second truncated hollow cones 5, 6 form a circumferential bulging-out, which can also be referred to as a circumferential bulge 12 or circumferential corrugation.

At the front end 2, the ultrasonic vibration transducer 1 has a tool 13. In the shown example of an embodiment, the tool 13 is rod-shaped. It is made, for example, from carbide or another material of sufficient hardness and strength. The tool 13 is preferably exchangeably fixed in the front end 2 of the ultrasonic vibration transducer 1. At the same time the tool 13 can also be an anchor which drills its own anchorage hole as a result of ultrasound application.

The hollow-cylindrical portion 4 of the ultrasonic vibration transducer 1 has an internal thread, into which a core 14 is screwed. The core 14 has the shape of a cone; it is located in the internal space 3 of the ultrasonic vibration transducer 1. It is, as mentioned, connected at the back end to the ultrasonic vibration transducer 1 by means of a thread 15. As a result, the ultrasonic vibration transducer 1 can vibrate relative to the core 14 so that the core 14 does not impede the amplitude amplification and impulse amplification of the ultrasonic vibration transducer 1. The ultrasonic vibration transducer 1 is adapted to suit the particular tool 13 by means of the exchangeable core 14, so that the system consisting of the tool 13, the ultrasonic vibration transducer 1 and a vibration generator 16 vibrates at natural frequency and/or at a frequency which is highly effective for drilling. For adaptation to suit a tool 13 of another weight and/or length, the core 14 is exchanged. With respect to the natural frequency, the vibration generator 16 is understood to mean its vibrating part.

At its back end, the ultrasonic vibration transducer 1 is clamped against the vibration generator 16. The vibration generator 16 is, for example, piezo-electric. The connection to the ultrasonic vibration transducer 1 is a screw connection by means of a screw 17, which is screwed into an internal thread in the core 14 of the ultrasonic vibration transducer 1. The screw 17 clamps the ultrasonic vibration transducer 1 against the vibration generator 16 and at the same time firmly clamps the core 14 without play in the ultrasonic vibration transducer 1.

The vibration generator 16 excites the ultrasonic vibration transducer 1 with longitudinal waves, which the ultrasonic vibration transducer 1 amplifies and transfers to the tool 13, as a result of which a hole can be drilled into building material, including hard building material such as, for example, concrete. In addition, for the purpose of vibration excitation, the ultrasonic vibration transducer 1, and with it the tool 13, can be driven in rotation. The hollow shape of the ultrasonic vibration transducer 1, especially the circumferential bulge 12, makes possible radial vibration, that is to say transverse vibration, and amplifies the longitudinal vibrations.

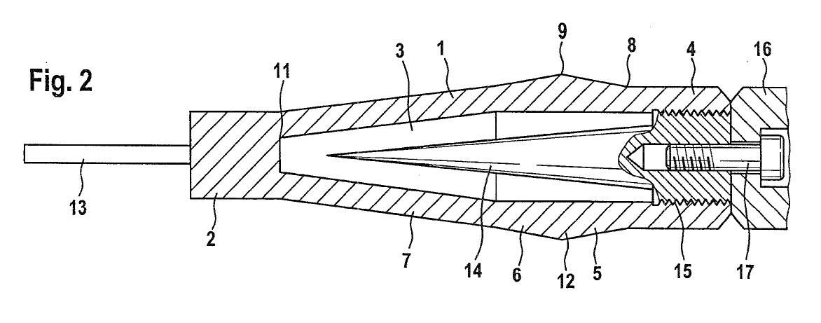

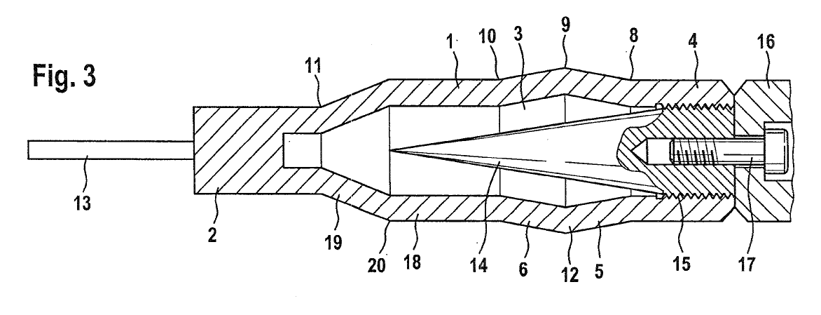

In contrast to the ultrasonic vibration transducer 1 shown in FIG. 1, the circumferential bulge 12 of the ultrasonic vibration transducer 1 of FIG. 2 is not concavely rounded but rather the inner wall is cylindrical. This means that the wall thickness is greater in the region of the circumferential bulge 12. In other respects, the ultrasonic vibration transducer 1 of FIG. 2 is constructed in the same manner as that of FIG. 1 and, to avoid repetition, reference should be made to the statements hereinbefore. The same components are provided with the same reference numerals in FIG. 2 as in FIG. 1.

Whereas the ultrasonic vibration transducers 1 shown in FIGS. 1 and 2 are intended for ultrasonic drilling in a hard material such as, for example, concrete, the ultrasonic vibration transducer 1 according to the invention that is shown in FIG. 3 is intended rather for softer materials such as brick or plaster. Compared to FIG. 1, in the case of the ultrasonic vibration transducer 1 of FIG. 3 the third truncated hollow cone, adjacent to the front end 2, has been replaced by a hollow cylinder 18 and a short truncated hollow cone 19, as a result of which an additional circumferential edge 20 is formed. The change in shape results in greater vibration amplitude of the tool 13, for which reduced impulse strength has to be accepted. The drilling progress in softer materials is improved as a result of this modified harmonisation or modified vibration and vibration transfer behaviour. In other respects, also, the ultrasonic vibration transducer 1 shown in FIG. 3 is constructed in the same manner and operates in the same manner as the ultrasonic vibration transducers 1 of FIGS. 1 and 2. To avoid repetition, for explanation of FIG. 3 reference should be made in that respect to the statements relating to FIGS. 1 and 2. The same components are provided with the same reference numerals in FIG. 3 as in FIGS. 1 and 2.

1. Ultrasonic vibration transducer for ultrasonic drilling, the ultrasonic vibration transducer (1) becoming narrower in the direction of the front end (2), characterised in that the ultrasonic vibration transducer (1) is a hollow body, the internal space (3) of which likewise becomes narrower in the direction of its front end (2).

2. Ultrasonic vibration transducer according to claim 1, characterised in that the ultrasonic vibration transducer (1) has, in its internal space (3), a core (14), which is releasably and firmly connected to the ultrasonic vibration transducer (1).

3. Ultrasonic vibration transducer according to claim 2, characterised in that the core (14) has localised connection to the ultrasonic vibration transducer (1).

4. Ultrasonic vibration transducer according to claim 3, characterised in that the core (14) is connected at the back end to the ultrasonic vibration transducer (1).

5. Ultrasonic vibration transducer according to claim 2, characterised in that a connection of the ultrasonic vibration transducer (1) to a vibration generator (16) firmly clamps the core (14) in the ultrasonic vibration transducer (1).

6. Ultrasonic vibration transducer according to claim 1, characterised in that the ultrasonic vibration transducer (1) is a body of revolution.

7. Ultrasonic vibration transducer according to claim 1, characterised in that the ultrasonic vibration transducer (1) and/or its internal space (3) becomes wider in the direction of its front end (2) in a region limited in the longitudinal direction.

8. Ultrasonic vibration transducer according to claim 1, characterised in that the ultrasonic vibration transducer (1) has at least one circumferential edge (8, 9, 10, 11, 20).
